(19) United States
(12) Patent Application Publication
(10) Pub. No.: US 2011/0202831 A1
(43) Pub. Date: Aug. 18, 2011

(54) DYNAMIC CACHE REBINDING OF PROCESSED DATA

(75) Inventors: Robert Bruckner, Redmond, WA (US); Christopher Hays, Monroe, WA (US); Mason J. Warner, Kirkland, WA (US); Nicoleta Cristache, Redmond, WA (US); Ian R. Roof, Seattle, WA (US)

(73) Assignee: Microsoft Coproration, Redmond, WA (US)

(21) Appl. No.: 12/705,825

(22) Filed: Feb. 15, 2010

(51) Int. Cl. G06F 17/21; G06F 7/00; G06F 17/30; G06F 12/00; G06F 12/08

(52) U.S. Cl. 715/246; 707/804; 711/118; 715/256; 711/E12.001; 711/E12.017; 707/E17.008; 707/E17.044; 707/E17.127

(57) ABSTRACT

Generating a report involves phases such as (a) database queries or other raw data accesses, (b) calculations such as data grouping, sorting, filtering, aggregation, (c) data presentation layout, (d) data formatting, and (e) rendering. When generating a modified version of a report, reusable interim results for phases (b), (c), and (d) are identified and retrieved from a cache instead of being recalculated. Newly calculated interim results are also cached for possible future use.

### BACKGROUND

Modern businesses, institutions, agencies, and other entities use software to help generate reports on which decisions are based. A report definition guides or influences data selection, layout, format, statistical calculations, and other computational processing, to help present data from a database, file, or other data source in a form that helps decision makers.

Some report definitions include facilities for grouping data. Within data-oriented applications such as some query and reporting tools, for example, data can be grouped before being displayed to the user in a report. Grouping of data can serve purposes such as clustering related data, subtotaling, and identification or removal of duplicate data. Grouping can be performed over a single data field, such as grouping a list of customers by state. Grouping can also be performed over multiple nested data fields, such as grouping a list of customers by state and then within each state grouping the customers by gender.

Some report definitions include facilities for controlling report item layout. For example, page size, page margins, page breaks, and line layout preferences or requirements can be specified in some configurations.

Some report definitions include facilities for controlling report format. For example, background images, borders, padding, text styles, and other format preferences or requirements can be specified in some configurations.

### SUMMARY

When a report definition is first used to generate a report, substantial processing may be performed, including phases such as (a) database queries, file reads, or other raw data accesses, (b) transformations and calculations such as data grouping, sorting, filtering, aggregation, (c) data presentation layout such as page size and repeating group headers, (d) data formatting such as bolding text, currency formatting, and highlighting outlier values, and (e) format rendering for a particular view such as a display screen window or a spreadsheet file.

When a modified version of a previously generated report is desired, some embodiments presented herein provide help reduce or minimize repetitive work by identifying and reusing certain previously obtained calculation results, which were placed in a cache during report generation. For example, when some embodiments receive a requested modification of a previously generated report, these embodiments automatically identify report processing interim result(s) which are computationally independent of the requested modification in terms of report generation. Particular attention is paid to identifying reusable data grouping results, layout results, and format results from report processing phases (b), (c), and (d) noted above. These embodiments access previously cached interim result(s), and use those interim result(s) to help generate a version of the report with the requested modifications. Newly calculated interim results are also cached for possible future use.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. These drawings only illustrate selected aspects and thus do not fully determine coverage or scope.

FIG. 1 is a block diagram illustrating a computer system having at least one processor, at least one memory, at least one report definition, and other items in an operating environment which may be present on multiple network nodes, and also illustrating configured storage medium embodiments;

FIG. 2 is a block diagram illustrating an example architecture designed to reuse report processing interim results;

FIG. 3 is a first flow chart illustrating steps of some process and configured storage medium embodiments;

FIG. 4 is a top portion of a second flow chart further illustrating steps of some process and configured storage medium embodiments; and

FIG. 5 is a bottom portion of the flow chart introduced in FIG. 4.

### DETAILED DESCRIPTION

Overview

When visualizing data and reporting data, users sometime employ an iterative process. It has become apparent to the inventors that report generation can be thus viewed as involving (a) retrieving the raw data on which the report is based, (b) transformations and calculations such as grouping of data, sorting, filtering, aggregation, (c) layout of the data presentation such as page size and repeating group headers, (d) formatting such as bolding text, currency formatting, highlighting outlier values, and (e) the rendering formats, e.g., by viewing a report on screen, then producing a Microsoft® Excel® format file, and printing the report with different page dimensions for the screen than for the file. (Microsoft and Excel are registered marks of Microsoft Corporation.)

Sometimes effort can be saved by storing a dataset, such as database query results, to use again later. However, it has become apparent to the inventors that merely reusing raw data involves redoing all down-stream transformations. That is, although reusing raw data can be more efficient than performing phases (a) through (e) in full each time a report is modified, reusing raw data merely improves phase (a) above.

Some embodiments herein help reduce latency arising from edits in a report by reusing interim results from phases (b), (c), and/or (d) noted above. In some configurations, only the work needed to accommodate the type of edit/change performed is performed, because other calculation results are cached and then reused. Re-using cached interim results can also help ensure data and calculation consistency across layout and format changes.

Some embodiments are compatible with approaches that reuse raw data during phase (a). Some embodiments are compatible with approaches that re-render a pre-existing otherwise unchanged artifact, that is, approaches that repeat phase (e) for an unmodified report. However, embodiments differ from such approaches in that embodiments are concerned with dynamic cache rebinding of interim results for phases (b), (c), and (d), and unless stated otherwise only with those phases (not with phases (a) or (e)). The granularity of preserved and reusable calculations can be determined dynamically, as discussed herein. Some embodiments identify fully or partially reusable interim transformation and calculation results by maintaining a dependency graph that determines which transformations can be reused as a result of (ancestor) dependent aspects of the underlying report artifact not having changed.

Reference will now be made to exemplary embodiments such as those illustrated in the drawings, and specific language will be used herein to describe the same. But alterations and further modifications of the features illustrated herein, and additional applications of the principles illustrated herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage, in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text. The inventors assert and exercise their right to their own lexicography. Terms may be defined, either explicitly or implicitly, here in the Detailed Description and/or elsewhere in the application file.

As used herein, a “computer system” may include, for example, one or more servers, motherboards, processing nodes, personal computers (portable or not), personal digital assistants, cell or mobile phones, and/or device(s) providing one or more processors controlled at least in part by instructions. The instructions may be in the form of software in memory and/or specialized circuitry. In particular, although it may occur that many embodiments run on workstation or laptop computers, other embodiments may run on other computing devices, and any one or more such devices may be part of a given embodiment.

A “multithreaded” computer system is a computer system which supports multiple execution threads. The term “thread” should be understood to include any code capable of or subject to synchronization, and may also be known by another name, such as “task,” “process,” or “coroutine,” for example. The threads may run in parallel, in sequence, or in a combination of parallel execution (e.g., multiprocessing) and sequential execution (e.g., time-sliced). Multithreaded environments have been designed in various configurations. Execution threads may run in parallel, or threads may be organized for parallel execution but actually take turns executing in sequence. Multithreading may be implemented, for example, by running different threads on different cores in a multiprocessing environment, by time-slicing different threads on a single processor core, or by some combination of time-sliced and multi-processor threading. Thread context switches may be initiated, for example, by a kernel's thread scheduler, by user-space signals, or by a combination of user-space and kernel operations. Threads may take turns operating on shared data, or each thread may operate on its own data, for example.

A “logical processor” or “processor” is a single independent hardware thread-processing unit. For example a hyperthreaded quad core chip running two threads per core has eight logical processors. Processors may be general purpose, or they may be tailored for specific uses such as graphics processing, signal processing, floating-point arithmetic processing, encryption, I/O processing, and so on.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory, and in some configurations both shared and local memories are present.

“Kernels” include operating systems, hypervisors, virtual machines, and similar hardware interface software.

“Code” means processor instructions, data (which includes constants, variables, and data structures), or both instructions and data.

“Automatically” means by use of automation (e.g., general purpose computing hardware configured by software for specific operations discussed herein), as opposed to without automation. In particular, steps performed “automatically” are not performed by hand on paper or in a person's mind; they are performed with a machine.

“Interim result” refers to a report generation processing result calculated after obtaining raw data (see phase (a) in the Summary above) and before rendering the report (see phase (e) in the Summary above). For example, interim results exclude raw unprocessed and unaccompanied data, and interim results may include sorting, filtering, aggregating, layout, and format calculation results.

Throughout this document, use of the optional plural “(s)” means that one or more of the indicated feature is present. For example, “result(s)” means “one or more results” or equivalently “at least one result”.

Whenever reference is made to data or instructions, it is understood that these items configure a computer-readable memory thereby transforming it to a particular article, as opposed to simply existing on paper, in a person's mind, or as a transitory signal on a wire, for example.

Operating Environments

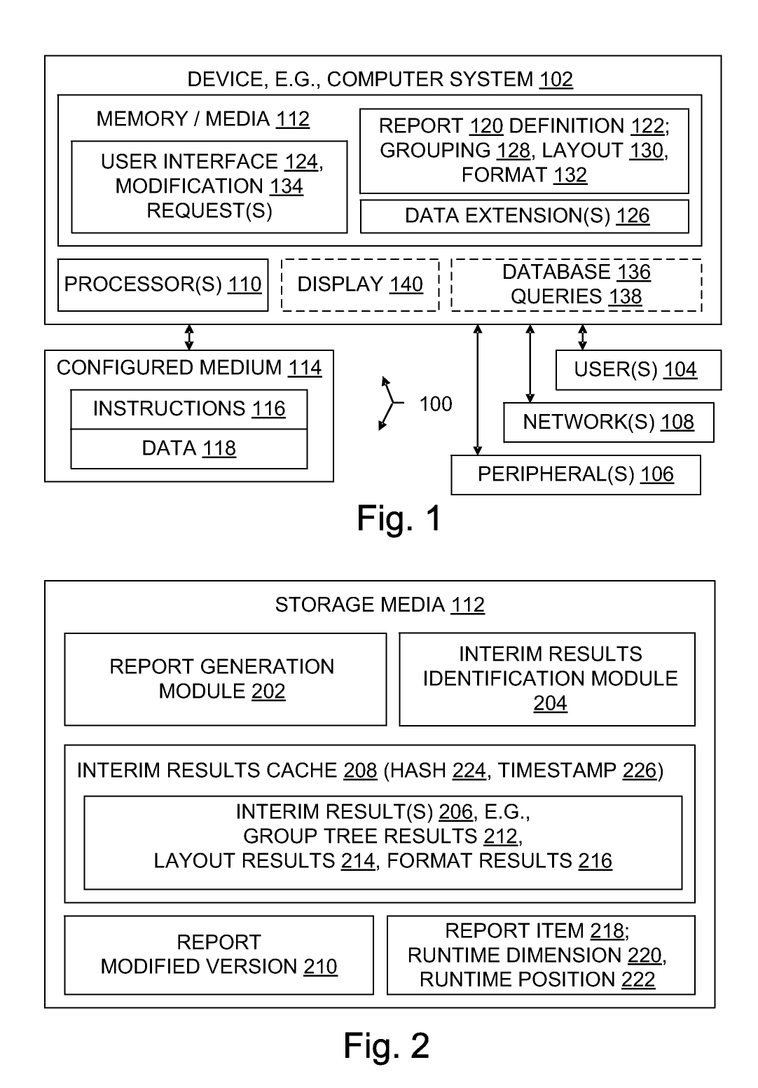

With reference to FIG. 1, an operating environment 100 for an embodiment may include a computer system 102. The computer system 102 may be a multiprocessor computer system, or not. An operating environment may include one or more machines in a given computer system, which may be clustered, client-server networked, and/or peer-to-peer networked.

Human users 104 may interact with the computer system 102 by using displays, keyboards, and other peripherals 106. System administrators, developers, engineers, and end-users are each a particular type of user 104. Automated agents acting on behalf of one or more people may also be users 104. Storage devices and/or networking devices may be considered peripheral equipment in some embodiments. Other computer systems not shown in FIG. 1 may interact with the computer system 102 or with another system embodiment using one or more connections to a network 108 via network interface equipment, for example.

The computer system 102 includes at least one logical processor 110. The computer system 102, like other suitable systems, also includes one or more computer-readable non-transitory storage media 112. Media 112 may be of different physical types. The media 112 may be volatile memory, non-volatile memory, fixed in place media, removable media, magnetic media, optical media, and/or of other types of non-transitory media (as opposed to transitory media such as a wire that merely propagates a signal). In particular, a configured medium 114 such as a CD, DVD, memory stick, or other removable non-volatile memory medium may become functionally part of the computer system when inserted or otherwise installed, making its content accessible for use by processor 110. The removable configured medium 114 is an example of a computer-readable storage medium 112. Some other examples of computer-readable storage media 112 include built-in RAM, ROM, hard disks, and other storage devices which are not readily removable by users 104.

The medium 114 is configured with instructions 116 that are executable by a processor 110; “executable” is used in a broad sense herein to include machine code, interpretable code, and code that runs on a virtual machine, for example. The medium 114 is also configured with data 118 which is created, modified, referenced, and/or otherwise used by execution of the instructions 116. The instructions 116 and the data 118 configure the medium 114 in which they reside; when that memory is a functional part of a given computer system, the instructions 116 and data 118 also configure that computer system. In some embodiments, a portion of the data 118 is representative of real-world items such as product characteristics, inventories, physical measurements, settings, images, readings, targets, volumes, and so forth. Such data is also transformed by as discussed herein, e.g., by binding, formatting, layout sizing and positioning, grouping, deployment, execution, modification, display, creation, loading, and/or other operations.

A report 120 defined by a report definition 122, tool user interface(s) 124, raw data source(s) such as data extensions 126, and other items shown in the Figures may reside partially or entirely within one or more media 112, thereby configuring those media. The report definition 122 may define aspects of the report such as item grouping(s) 128, layout 130, and format 132. The user interface 124 may be used to enter modification 134 requests to modify these or other aspects of the report 120. Data extensions 126 may include, for example, XML files, flat files, web services, and/or database(s) 136. The report definition 122 may include, or cause automatic generation of, database queries 138. An operating environment may also include a display 140 and other hardware such as buses, power supplies, and accelerators, for instance.

Some items are shown in outline form in FIG. 1 to emphasize that they are not necessarily part of the illustrated operating environment, but may interoperate with items in the operating environment as discussed herein. It does not follow that items not in outline form are necessarily required, in any Figure or any embodiment.

Systems

FIG. 2 illustrates an architecture which is suitable for use with some embodiments. A report generation module 202 and an interim results identification module 204 may each be implemented in software, firmware, and hardware, for example.

In some embodiments and configurations, the report generation module 202 generates an initial version of a report 120 from a definition 122, and during that initial version generation the module 202 places certain interim results 206 in a cache 208 for possible later use during generation of modified version(s) 210 of the report 120. Interim results can be managed using hash 224 values, timestamp 226 values, and/or other mechanisms which allow the report generation module 202 to store and retrieve cache results 206 for reuse during report generation as discussed herein. In some embodiments, the report generation module 202 retrieves cached interim results 206 and uses them during generation of modified version(s) 210 of the report 120. That is, the report generation module 202 may cache interim results 206, it may retrieve cached interim results 206, or it may do both, depending on the embodiment and what the embodiment is being asked by a user to do.

The interim results 206 may include group tree results 212 calculated during an instance of phase (b) involving transformations and calculations such as grouping of data, sorting, filtering, aggregation, for example. In some embodiments, a group tree is a logical structure that describes the result of operations that include, but are not limited to, grouping of data and groups, sorting of data and groups, filtering of data and groups, and aggregations. A hierarchy may exist within the data and groups represented by the group tree. The interim results 206 may also or alternately include layout results 214 calculated during an instance of phase (c) involving layout of the data presentation such as page size, repeating group headers, for example. The interim results 206 may also or alternately include format results 216 calculated during an instance of phase (d) involving formatting such as bolding text, currency formatting, and highlighting outlier values, for example. These examples are merely illustrative, neither required nor exhaustive. The interim results 206 may pertain to particular report item(s) 218 and/or to particular aspects of tables, graphs, text, and other report items such as a runtime-determined dimension 220 of a report item or a runtime-determined position 222 of a report item.

In some embodiments peripherals 106 such as human user I/O devices (screen, keyboard, mouse, tablet, microphone, speaker, motion sensor, etc.) will be present in operable communication with one or more processors 110 and memory. However, an embodiment may also be deeply embedded in a system, such that no human user 104 interacts directly with the embodiment. Software processes may be users 104.

In some embodiments, the system includes multiple computers connected by a network. Networking interface equipment can provide access to networks 108, using components such as a packet-switched network interface card, a wireless transceiver, or a telephone network interface, for example, will be present in a computer system. However, an embodiment may also communicate through direct memory access, removable nonvolatile media, or other information storage-retrieval and/or transmission approaches, or an embodiment in a computer system may operate without communicating with other computer systems.

Some embodiments operate in a “cloud” networked computing environment and/or a “cloud” storage environment. For example, report definitions 122 may be stored on multiple devices/systems 102 in a networked system cloud, reports 120 may be generated on yet other devices within the cloud, and stored on still other cloud device(s)/system(s) 102. Likewise, interim results 206 may be stored in non-volatile caches 208 on different devices than the devices which retrieve the cached interim results for use in generating modified report versions 210.

With reference to FIGS. 1 and 2, some embodiments provide a computer system 102 with a logical processor 110 and a memory medium 112 configured by circuitry, firmware, and/or software to efficiently reuse interim results when generating reports as described herein. For example, one embodiment includes a memory in operable communication with a logical processor, a report definition 122 residing in the memory, a requested modification 134 of the report definition (also residing in the memory), and at least one report processing interim result 206 (which also resides in the memory).

The interim result has a specific value, but “interim result” also encompasses the role played by that value in report generation. The interim result 206 is computationally independent of the requested modification in terms of report generation, meaning that the interim result need not be recalculated in order to generate a report having the requested modification(s) 134 and having only those modifications. Differently stated, an interim result 206 can be plugged into a modified report generation process without undesired report modifications following as a consequence of re-using the interim result instead of recalculating. In some embodiments, a report includes several report items and regions, and different types of interim results may be reusable per region of a report.

In some embodiments, a modified version 210 of the report also resides in the memory. The modified version 210 is based on at least the requested modification 134 and the cached interim result(s) 206. That is, some embodiments include a modified report, while other embodiments do not.

With regard to modifications 134, in some embodiments possible modifications include changes one or more of the following: Page Size, Page Margins, Repeating group data header, Page breaks defined in the Report Definition Language (RDL) definition 122 (or otherwise), Visibility, RDL “Keep Together” property, RDL “Keep With” property, RDL CanGrow, CanShrink for text boxes, RDL Autosize Images, Fixed size report item (clipped content or scroll). Properties may be represented using XML elements in RDL, for example. Modifications 134 may also include operations to Add new report items, Delete report items, Add/delete groups, and/or Add/delete rows/columns, for example.

Some embodiments include a report generation module 202. Module 202 is configured to generate a modified version of the report based on at least the requested modification and the cached interim result(s).

Some embodiments include an interim results identification module 204. Module 204 is configured to identify at least one report processing interim result which is computationally independent of the requested modification in terms of report generation. In particular, in some embodiments an interim results identification module 204 is configured to identify at least one report processing interim result 206 in the form of a report item 218 runtime dimension 220 which is computationally independent of the requested modification in terms of report generation. In some embodiments an interim results identification module 204 is configured to identify at least one report processing interim result 206 in the form of a report item 218 runtime position 222 which is computationally independent of the requested modification in terms of report generation.

In some embodiments, an interim results identification module 204 is configured to identify one or more of the following as report processing interim results 206 of the {indicated kind} when they are computationally independent of the requested modification in terms of report generation: a data grouping {group tree} result, a data row sorting {group tree} result, a group instance sorting {group tree} result, a data row filtering {group tree} result, a group instance filtering {group tree} result, an aggregation at grouping scope {group tree} result, a page size {layout} result, a page margin {layout} result, a repeating group data header {layout} result, a page breaks {layout} result, a keep-together {layout} result (to keep lines or other items together on the same page), a keep-with {layout} result (to keep items together if they are moved within the report), a text box sizing {layout} result, an image sizing {layout} result, a report item runtime position {layout}, a report item runtime dimension {layout}, a background {format} result, a border {format} result, a padding {format} result, a text style {format} result, a text value {format} result. One way to think about keep-together vs. keep-with is that keep-together applies to items within a report item or data region (e.g. a table header, a group header within a table, nested report items); keep-with defines the relationship of non-nested and otherwise unrelated reportitems. For example, if a table spans multiple pages at runtime due to underlying amount of data and page layout settings, then all the reportitems that are “kept with” the table are repeated for each page that contents of the table is visible. More generally, the report processing interim results 206 residing in the memory may include interim group tree result(s) 212, interim layout result(s) 214, and/or interim format result(s) 216, pertaining respectively, for example, to phases (b), (c), (d) noted above.

Processes

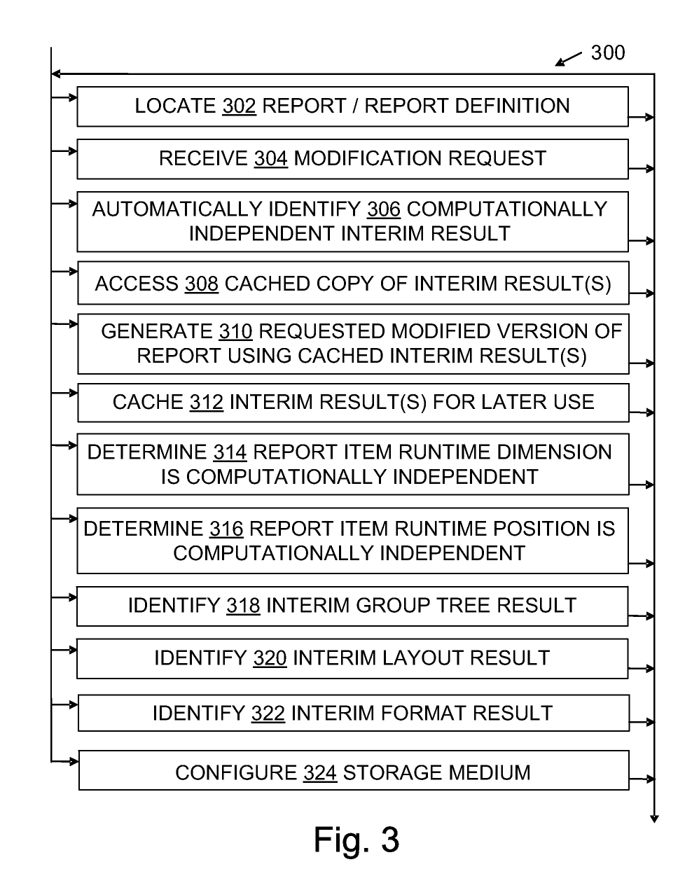

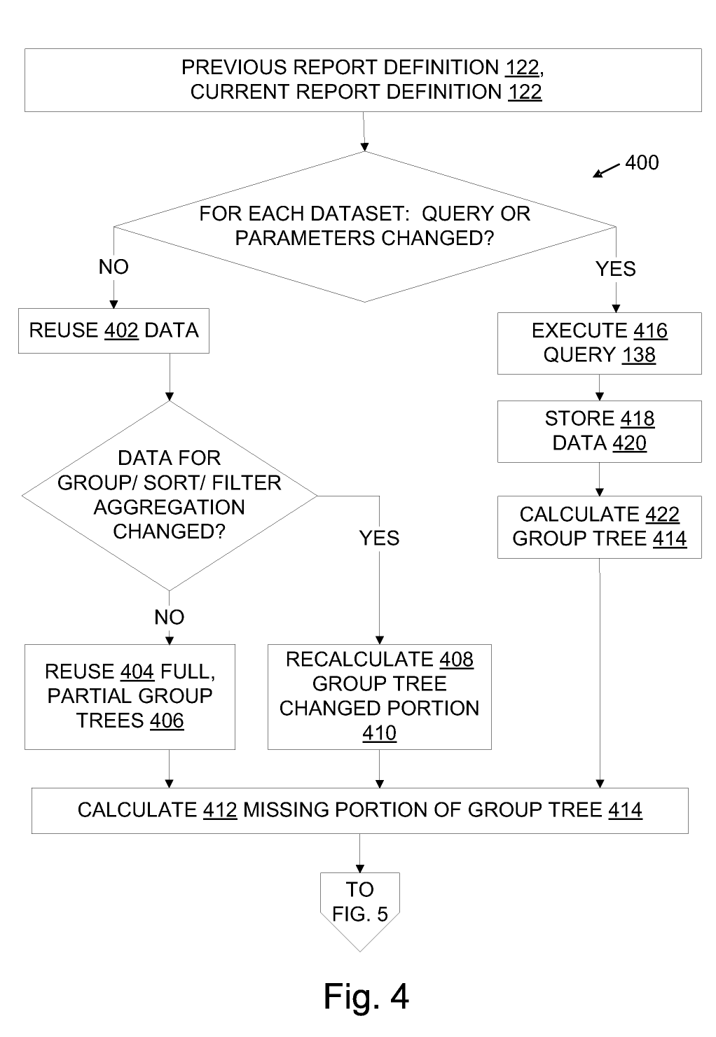

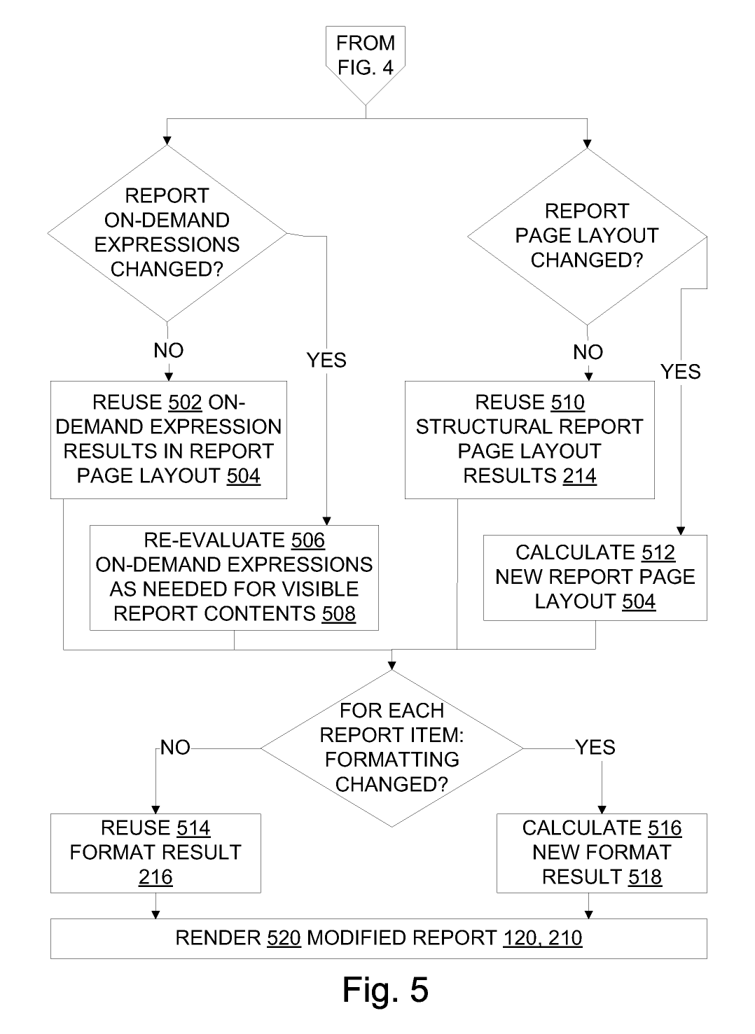

FIG. 3 illustrates some process embodiments in a flowchart 300. FIGS. 4 and 5 together illustrate some process embodiments in a second flowchart 400. Processes shown in the Figures may be performed in some embodiments automatically, e.g., by a report generation module 202 and/or an interim results identification module 204 under control of a script requiring little or no contemporaneous user input. Processes may also be performed in part automatically and in part manually unless otherwise indicated. In a given embodiment zero or more illustrated steps of a process may be repeated, perhaps with different parameters or data to operate on. Steps in an embodiment may also be done in a different order than the top-to-bottom order that is laid out in FIG. 4. Steps may be performed serially, in a partially overlapping manner, or fully in parallel. The order in which a flowchart is traversed to indicate the steps performed during a process may vary from one performance of the process to another performance of the process. The flowchart traversal order may also vary from one process embodiment to another process embodiment. Steps may also be omitted, combined, renamed, regrouped, or otherwise depart from the illustrated flow, provided that the process performed is operable and conforms to at least one claim.

Examples are provided herein to help illustrate aspects of the technology, but the examples given within this document do not describe all possible embodiments. Embodiments are not limited to the specific implementations, arrangements, displays, features, approaches, or scenarios provided herein. A given embodiment may include additional or different features, mechanisms, and/or data structures, for instance, and may otherwise depart from the examples provided herein.

With attention to FIG. 3, during a report locating step 302 an embodiment locates a report 120, a report definition 122, or both. Some configurations utilize a report definition 122 which is stored separately (e.g., in different file(s)) than the defined report, whereas other configurations utilize reports which are self-defining (e.g., in XML format) or which are “implicitly” defined (cf. program source code is implicitly defined by a compiler or interpreter). Some configurations utilize a report definition 122 which conforms with a standard or proposed standard, such as the Report Definition Language (“RDL”) standard proposed by Microsoft Corporation, for example. Step 302 may be accomplished using file systems, indexes, registries, directories, direct user input, and/or other mechanism(s), for example.

During a modification request receiving step 304, an embodiment receives a request identifying one or more desired modifications 134 to the report/report definition located 302 in the previous step. In a variation, the modification request also identifies the report/report definition to be modified. In another variation, the report/report definition to be modified is identified and located 302 after the modification request is received. The modification request may be received from a user interface 124, from a human or software user 104. In general, any aspect of a report/report definition may be modified, but in a given embodiment a given modification will not necessarily permit use of interim results 206 as discussed herein. Accordingly, attention is focused here on modifications which leave some aspect of a previously generated report/report definition unchanged, thereby making possible the use of interim results 206.

During an interim result identifying step 306, and embodiment automatically identifies computationally independent interim result(s) 206. Whether a given result of previous report generation processing is computationally independent depends not only on the role played by that result during report generation (and hence on the report generation implementation) but also on the particular modification(s) 134 requested. However, computational independence can be determined by applying granularity and dependency.

Pursuant to a granularity determination, an embodiment divides results into phases (b), (c), (d) noted above and into particular results (such as the particular examples of results 212, 214, 216 listed herein). In some embodiments, a report includes several report items and regions, and different types of interim results may be reusable per region of a report. Pursuant to a dependency determination, an embodiment identifies dependencies between the particular granularity results and the changes (modifications 134) that will be made to the report/report definition. Results upon which none of the requested changes depend are candidate interim results 206. In some embodiments, the dependency graph has a fine granularity. Related to this, an Additional Examples section below contains several specific examples. More generally, a given report may be composed of several regions (e.g. a table, a chart). Typically a modification of a report does not affect all regions; as a result, for some portions of the report the system may be able to fully reuse previous calculations results (from phases (a) through (d)), while regions that were edited may only allow less reuse of interim calculation results. For example, in a report with a table and a chart, the contents of the table header is bolded, which doesn't affect the chart, and doesn't necessarily affect the table detail contents.

To actually reuse a candidate result, the embodiment also relies on having a copy of the result available, e.g., a cached 208 copy. Accordingly, during a result accessing step 308, an embodiment accesses a cached copy of an interim result 206. The cache 208 may be implemented using any storage medium 112, volatile (e.g., RAM) or non-volatile (e.g., hard disk). In some embodiments, the cache 208 includes only volatile storage; in some the cache 208 includes at least non-volatile storage and may also include volatile storage. File systems, memory management systems, hashes, and other familiar mechanisms may be utilized during step 308.

During a modified report/report definition generating step 310, an embodiment generates a modified version 210 of a report/report definition, utilizing at least one re-used interim result 206 and making at least one requested modification 134 from a previously generated report/report definition. Familiar report generation mechanisms can be used in portions of the generation process which do not utilize cached interim result(s) 206 from a previous generation.

However, the familiar report generation mechanisms which do not re-use results can nonetheless be modified to update the cache 208 with results that may be used in a subsequent generation process. Accordingly, during a caching step 312, an embodiment stores a calculated result in a cache 208 for possible use during subsequent generation of modified versions 210. Caching step 312 may maintain a registry, directory, index, hash table, or other data structure which distinguishes cached interim results from one another and which identifies the particular version 210 of the report during whose generation the result in question was calculated.

As a particular example of identifying step 306, during a dimension independence determining step 314, an embodiment determines that a report item runtime dimension 220 is computationally independent and hence that a cached interim result for that dimension can be used in generating a report/report definition version 210.

As another particular example of identifying step 306, during a position independence determining step 316, an embodiment determines that a report item runtime position 222 is computationally independent and hence that a cached interim result for that position can be used in generating a report/report definition version 210.

As another particular example of identifying step 306, during an interim group tree result identifying step 318, an embodiment identifies a report group tree result of the kind pertaining to phase (b) identified above as being computationally independent and hence a candidate interim result 206.

As another particular example of identifying step 306, during an interim layout result identifying step 320, an embodiment identifies a report layout result of the kind pertaining to phase (c) identified above as being computationally independent and hence a candidate interim result 206.

As another particular example of identifying step 306, during an interim format result identifying step 322, an embodiment identifies a report format result of the kind pertaining to phase (d) identified above as being computationally independent and hence a candidate interim result 206. Steps 314-322 may be accomplished using granularity determinations and dependency determinations as discussed herein.

During a memory configuring step 324, a memory medium 112 is configured by an interim results identification module 204, by interim result(s) 206 in a cache or in re-use, or otherwise in connection with efficient re-use of results from phases (b), (c), and/or (d) above as discussed herein, and only from those phases, not from phases (a) or (e).

Turning now to FIGS. 4 and 5, the illustrated process begins with a previous report definition 122 and a current report definition 122, as indicated in FIG. 4. The difference between the previous and current definitions corresponds to requested modifications 134. As noted, some embodiments are compatible with reuse 402 of raw data 420. Accordingly, in the illustrated process a test is made for each dataset used in the report to check whether query, parameters or other aspects of the raw data have changed. If not, then the raw data is reused 402. Otherwise, queries 138 are executed 416 to obtain updated raw data 420, which is stored and also used to calculate 422 a group tree 414 data structure. The group tree 414 structure reflects aspects of data grouping for the purpose of report generation, such as item nesting, group definitions (e.g., months grouped into years), sorting, and filtering.

If data for grouping, sorting, filtering and the like (phase (b) operations) has not changed, then cached interim group tree results 212 can be identified and re-used 404 in partial of full group trees 406. If such data have changed, then results are recalculated 408 for at least the changed portion 410 of the group tree(s). If any portion of the group tree 414 needed for report generation is not provided by the foregoing steps, then those missing portion(s) are calculated 412. The flowchart then continues in FIG. 5.

If some or all report on-demand expressions have not changed, then the illustrated process reuses 502 such on-demand expression results 214 in generating a report page layout 504. Otherwise, on-demand expressions which have changed are re-evaluated 506 as need to produce visible report contents 508.

Similarly, if some or all report page layout has not changed, then the illustrated process reuses 510 structural report page layout results 214 in generating a report page layout 504. Otherwise, new report page layout 504 is calculated 512.

As to formatting, the process reuses 514 format results 216 for report items whose formatting is unchanged (that is, not being modified for the current report definition). The process calculates 516 new format results 518 for items whose format is being modified.

Finally, the current report definition and the reused/calculated results are utilized to render 520 a modified report 120, that is, a report version 210 that includes the modification(s) 134 requested as part of the current report definition.

The foregoing steps and their interrelationships are discussed in greater detail below, in connection with various embodiments.

In some embodiments, a process for generating a report includes receiving 304 in the memory a requested modification of a report 120 that is defined to include at least one database query 138. The process also includes automatically identifying 306 at least one report processing interim result which is computationally independent of the requested modification in terms of report generation, accessing 308 a cached copy of the identified interim result(s) 206, and generating 310 a modified version of the report in the memory based on at least the requested modification and the cached interim result(s).

Some embodiments provide a process for generating a report, which includes locating 302 a report 120 derived from data retrieved from a data extension 126 (which does not necessarily include a database query in this variation), receiving 304 in memory a requested modification 134 of the report, automatically identifying 306 at least one report processing interim result 206 (which is computationally independent of the requested modification in terms of report generation), accessing 308 a cached copy of the identified interim result(s), and generating 310 a modified version 210 of the report in the memory based on at least the requested modification and the cached interim result(s). An aspect of this process is the relationship between the requested modification to a report and the report processing interim result that is cached and reused. That is, what will be reused from cache depends on what modifications will be made to the report.

“Interim result” is a term coined for use herein. Examples of interim results 206 are given herein, with the understanding that interim results exclude raw data, namely, data that has not previously been subjected to at least phase (b), (c), or (d) of the report generation process in connection with the current sequence of reports. A sequence of reports includes an initial report and one or more subsequent modified reports derived from the initial report.

In some embodiments, the locating step locates 302 a report which is derived from data retrieved from at least one of the following data extensions 126: a database 136, an XML file, a flat file, a web service.

In some embodiments, the identifying step automatically identifies 306 at least one interim group tree result 212 (a.k.a. “group tree interim result”) which is subsequently used in generating the modified version of the report. For example, in some embodiments the identifying step automatically identifies 306 at least one of the following interim group tree results 212: a data grouping group tree result, a data row sorting group tree result, a group instance sorting group tree result, a data row filtering group tree result, a group instance filtering group tree result, an aggregation at grouping scope group tree result.

In some embodiments, the identifying step automatically identifies 306 at least one interim layout result 214 (a.k.a. “layout interim result”) which is subsequently used in generating the modified version of the report. For example, in some embodiments the identifying step automatically identifies 306 at least one of the following interim layout results: a page size layout result, a page margin layout result, a repeating group data header layout result, a page breaks layout result, a keep-together layout result, a keep-with layout result, a text box sizing layout result, an image sizing layout result.

In some embodiments, the identifying step automatically identifies 306 at least one interim format result 216 (a.k.a. “format interim result”) which is subsequently used in generating the modified version of the report. For example, in some embodiments the identifying step automatically identifies 306 at least one of the following interim format results: a background format result, a border format result, a padding format result, a text style format result, a text value formatting result. In some embodiments, format interim results 216 include one or more of the following: Background (Color, Image, HatchType); Borders (color, style, width); Padding (Left, Top, Right, Bottom); Text style—Font (style, family, size, weight), Line Height, Direction, Writing Mode (affects how the text is broken in lines and consequently might have an impact on runtime size of the textbox); Text color; Text Align; Vertical Align; Text effect; Formatted Text Value, based on style properties like Format, Language, Calendar, Numeral Language, Numeral Variant.

With regard to layout interim results, in some embodiments calculation of report item runtime size, width and height, can be re-used as long as there are no data, layout or format changes with impact on layout of inner report items or report item content. Accordingly, in some embodiments, the identifying step 306 automatically determines 314 that a report item runtime dimension 220 is computationally independent of the requested modification 134 in view of at least one of the following: an unchanged layout of inner report items for the modified version of the report, an unchanged layout of report item content for the modified version of the report, an unchanged format of inner report items for the modified version of the report, an unchanged format of report item content for the modified version of the report.

In some embodiments calculation of item runtime position, left and top, relative to its parent, can be re-used as long as there are no data, layout or format changes with impact on layout of inner report items, report item content or report item siblings. Accordingly, in some embodiments, the identifying step 306 automatically determines 316 that a report item runtime position 222 is computationally independent of the requested modification 134 in view of at least one of the following: an unchanged layout of inner report items for the modified version of the report, an unchanged layout of report item content for the modified version of the report, an unchanged layout of report item sibling(s) for the modified version of the report, an unchanged format of inner report items for the modified version of the report, an unchanged format of report item content for the modified version of the report, an unchanged format of report item sibling(s) for the modified version of the report.

Configured Media

Some embodiments include a configured computer-readable storage medium 112. Medium 112 may include disks (magnetic, optical, or otherwise), RAM, EEPROMS or other ROMs, and/or other configurable memory, including in particular non-transitory computer-readable media (as opposed to wires and other propagated signal media). The storage medium which is configured may be in particular a removable storage medium 114 such as a CD, DVD, or flash memory. A general-purpose memory, which may be removable or not, and may be volatile or not, can be configured into an embodiment using items such as an interim results identification module 204 performing granularity and dependency determinations, and interim results 206, in the form of data 118 and instructions 116, read from a removable medium 114 and/or another source such as a network connection, to form a configured medium. The configured medium 112 is capable of causing a computer system to perform process steps for transforming data through interim result identification, caching, and reuse as disclosed herein. FIGS. 1 through 5 thus help illustrate configured storage media embodiments and process embodiments, as well as system and process embodiments. In particular, any of the process steps illustrated in FIGS. 3 though 5, or otherwise taught herein, may be used to help configure a storage medium to form a configured medium embodiment.

Additional Examples

Additional details and design considerations are provided below. As with the other examples herein, the features described may be used individually and/or in combination, or not at all, in a given embodiment.

Those of skill will understand that implementation details may pertain to specific code, such as specific APIs and specific sample programs, and thus need not appear in every embodiment. Those of skill will also understand that program identifiers and some other terminology used in discussing details are implementation-specific and thus need not pertain to every embodiment. Nonetheless, although they are not necessarily required to be present here, these details are provided because they may help some readers by providing context and/or may illustrate a few of the many possible implementations of the technology discussed herein.

One approach is described below in two parts. A first part provides detail about Microsoft® SQL Server® Reporting Services reuse of raw data (marks of Microsoft Corporation). This first part corresponds to phase (a), and is provided here by way of background. A second part discusses a particular implementation of interim results 206 reuse. Detailed information is provided, with the understanding that details may pertain to specific code and thus need not appear in every embodiment. Likewise, identifiers and some terminology used in discussing details are implementation-specific and thus need not pertain to every embodiment, although they may help particular readers understand aspects of some embodiments.

As to the first part, namely, reuse of raw data, Microsoft® SQL Server® Reporting Services has server and client components. It uses a rich client Report Builder for report authoring. Report Builder allows the user to switch between a design canvas in which the structural aspects of the report can be viewed and edited, and a preview mode which visualizes the report with data as it will be seen by consumers of the report when it is published to the server. A significant part of the latency when switching to the preview mode is the execution of the queries 138 which populate the data in the report. Prior to data reuse implementation, even cosmetic changes in the report could require re-execution of the queries. The report authoring environment operates by constructing a so-called edit session that is connected with the report server. At any time, the edit session consists of the following pieces:

A context location, which serves as the root of the report execution and allows relative paths to reference items that are only available on the report server (e.g. subreports, shared data sources), but not in the client environment, and are resolved at runtime (aka report preview in the client tool).

A set of data caches, which are parameterized by report query 138 parameters.

A computed hash code of the portions of the report which are relevant to dataset retrieval (e.g. query commandtext, query parameter values, data source information). This is subsequently referred to as a data cache hash.

The user principal that started the edit session, for security purposes to ensure that other users cannot reference this same edit session.

When the context report in the edit session is initially rendered, the data returned from the dataset queries is cached on the server. When the context report is changed, new data cache hash values are computed based on the contents of the modified report, and compared to the pre-existing values. If values match, the corresponding cached data entries for that edit session are reused 402. Otherwise, dataset queries are evaluated and data is retrieved (per step 416) from data sources before other transformations are performed and the report is rendered. In addition, the SQL Server® 2008 R2 release of the report server includes the ability to transparently combine stored 418 and fresh data in the same report rendering (e.g. through the shared dataset feature with explicit caching and cache refresh). The timestamp (freshness) for each dataset used is available via the RDL expression language and can be surfaced in the report rendering 520 as well.

As to the second part, namely, reuse of a variety of types of processed data (interim results 206), depending on the type of modifications 134 by the user 104 to a report 120, more than just the raw data 420 can be reused. As noted herein, some embodiments implicitly or explicitly classify the types of changes into the following phase-based categories: (a) data, (b) transformation and related calculations, (c) layout, (d) format, (e) rendering.

As to category (b), several types of calculations are dependent on raw data and can be cached 312 if there are no time-dependencies in those calculations: grouping of data, sorting of data rows and sorting of group instances, filtering of data rows and filtering of group instances, aggregations (at grouping scopes and outside). Group variables may be considered by some in conjunction with these calculations, but are discussed separately in U.S. patent application Ser. No. 11/669,723 filed Jan. 31, 2007 and incorporated herein by reference. For example, if the user changes the page layout to use portrait instead of landscape, at least some and possibly all category (b) calculations can be reused. Furthermore, if the user wants group headers to repeat on each page, category (b) calculations can be reused. In addition, other types of calculations in the context of Reporting Services, such as on-demand evaluated RDL expressions, can also be reused if the RPL (report page layout stream) is cached 312.

Note that the reuse of category (b) calculations is scalable. For the following set of examples, suppose a report has two different datasets, DataSet1 and DataSet2.

In Example 1, the user has an existing report 120, and changes the query of DataSet2. An effect is that, since the query definition of DataSet2 changes, the previously cached raw data of DataSet2 cannot be reused. Consequently category (b) calculations directly dependent on DataSet2 cannot be reused. However, the data cache and the category (b) calculations that depend on DataSet1 can be accessed 308 and reused during modified report version generation 310.

In Example 2, the user creates a report 120 that shows a report item 218 table1 of data for DataSet1, and a table2 of data for DataSet2. Then the user adds a report item 218 chart visualization of data contained in DataSet2 next to the table2. An effect is that all category (b), (c), (d) calculations for table1 and table2 can be reused, including layout, formatting, and possibly also rendering (if the chart visualization doesn't overlap or interact with the rendering of the tables). For the chart, additional category (b) calculations are performed upon the first previewing of that modified report, and added to the calculation cache 208. Subsequent previewing of the report can reuse those calculations; previewing is an example of an invocation of report generation 310.

In Example 3, as a first step a user creates a report 120 with data shown in table1 below, grouped by sales employee name:

| Employee Name | Sales |
|---|---|
| Pak, Jae | $1,404,463.32 |
| Mitchell, Linda | $1,290,109.46 |
| Ito, Shu | $916,141.91 |
| Carson, Jillian | $1,570,081.31 |
| Blythe, Michael | $1,693,901.89 |

As a second step of Example 3, the user adds a chart next to the table. The chart is grouped by the same criteria (employee name), but sorted differently:

As a third step of Example 3, the user adds the same sort (namely, sort by sales, ascending) for the table group, and the chart category axis:

Now consider what is happening in each step. At the first step of Example 3, if the raw data is not yet stored, the dataset query 138 is executed 416, data 420 is retrieved and cached (stored 418). Down-stream calculations are then performed. At the second step of Example 3, the cached data is reused 402. Furthermore, the new chart is not only bound to the same data as the table, but also uses the same grouping criteria (a group tree interim result 212). As a result, not only the data, but also the category (b) group calculation can be reused. At the third step of Example 3, since the sort criteria of the table grouping and the chart grouping are identical, the category (b) calculation group, sort, and aggregate calculations can be reused. The approach of reusing category (b) data calculations at a scalable level is applied in a similar way for category (c) layout changes of the data presentation (e.g. page size, repeating group headers), and for category (d) formatting changes (e.g. bolding text, currency formatting, highlighting outlier values). Hashes 224, timestamps 226, and/or other mechanisms can be implemented as part of the interim results cache 208 storing and retrieval of interim results 206.

One specific internal implementation performed caching of “RPL” (report page layout format) and directly applied layout and format changes in RPL, thereby fully reusing all calculation results including on-demand evaluated RDL expression results.

More generally, dynamic application of processed data reuse can result in a significant reduction of latency when a user applies changes to a report artifact (report 120/report definition 122) and renders the updated report.

### CONCLUSION

Although particular embodiments are expressly illustrated and described herein as processes, as configured media, or as systems, it will be appreciated that discussion of one type of embodiment also generally extends to other embodiment types. For instance, the descriptions of processes in connection with FIGS. 3 through 5 also help describe configured media, and help describe the operation of systems and manufactures like those discussed in connection with other Figures. It does not follow that limitations from one embodiment are necessarily read into another. In particular, processes are not necessarily limited to the data structures and arrangements presented while discussing systems or manufactures such as configured memories.

Not every item shown in the Figures need be present in every embodiment. Conversely, an embodiment may contain item(s) not shown expressly in the Figures. Although some possibilities are illustrated here in text and drawings by specific examples, embodiments may depart from these examples. For instance, specific features of an example may be omitted, renamed, grouped differently, repeated, instantiated in hardware and/or software differently, or be a mix of features appearing in two or more of the examples. Functionality shown at one location may also be provided at a different location in some embodiments.

Reference has been made to the figures throughout by reference numerals. Any apparent inconsistencies in the phrasing associated with a given reference numeral, in the figures or in the text, should be understood as simply broadening the scope of what is referenced by that numeral.

As used herein, terms such as “a” and “the” are inclusive of one or more of the indicated item or step. In particular, in the claims a reference to an item generally means at least one such item is present and a reference to a step means at least one instance of the step is performed.

Headings are for convenience only; information on a given topic may be found outside the section whose heading indicates that topic.

All claims as filed are part of the specification.

While exemplary embodiments have been shown in the drawings and described above, it will be apparent to those of ordinary skill in the art that numerous modifications can be made without departing from the principles and concepts set forth in the claims. Although the subject matter is described in language specific to structural features and/or procedural acts, it is to be understood that the subject matter defined in the appended claims is not necessarily limited to the specific features or acts described above the claims. It is not necessary for every means or aspect identified in a given definition or example to be present or to be utilized in every embodiment. Rather, the specific features and acts described are disclosed as examples for consideration when implementing the claims.

All changes which come within the meaning and range of equivalency of the claims are to be embraced within their scope to the full extent permitted by law.

What is claimed is:

1. A process for generating a report, the process utilizing a device which has at least one logical processor in operable communication with at least one memory, the process comprising the steps of:
locating a report;
receiving in the memory a requested modification of the report;
automatically identifying at least one report processing interim result which is computationally independent of the requested modification in terms of report generation;
accessing a cached copy of the identified interim result(s); and
generating a modified version of the report in the memory based on at least the requested modification and the cached interim result(s).

2. The process of claim 1, wherein the locating step locates a report which is derived from at least one of the following data extensions: a database, an XML file, a flat file, a web service.

3. The process of claim 1, wherein the identifying step automatically identifies at least one of the following interim group tree results:
a data row sorting result;
a data row filtering result;
a data grouping result;
a group instance sorting result;
a group instance filtering result;
an aggregation at grouping scope result.

4. The process of claim 1, wherein the identifying step automatically identifies at least one interim layout result which is subsequently used in generating the modified version of the report.

5. The process of claim 1, wherein the identifying step automatically identifies at least one interim format result which is subsequently used in generating the modified version of the report.

6. The process of claim 1, wherein the identifying step comprises automatically determining that a report item runtime dimension is computationally independent of the requested modification in view of at least one of the following:
an unchanged layout of report item content for the modified version of the report;
an unchanged format of report item content for the modified version of the report;
an unchanged layout of inner report items for the modified version of the report;
an unchanged format of inner report items for the modified version of the report.

7. The process of claim 1, wherein the identifying step comprises automatically determining that a report item runtime position is computationally independent of the requested modification in view of at least one of the following:
an unchanged layout of report item content for the modified version of the report;
an unchanged format of report item content for the modified version of the report;
an unchanged layout of inner report items for the modified version of the report;
an unchanged format of inner report items for the modified version of the report;
an unchanged layout of report item sibling(s) for the modified version of the report;
an unchanged format of report item sibling(s) for the modified version of the report.

8. A computer-readable non-transitory storage medium configured with data and with instructions that when executed by at least one processor causes the at least one processor to perform a process for generating a report, the process comprising the steps of:
receiving in the memory a requested modification of a report defined to include data from at least one database query;
automatically identifying at least one report processing interim result which is computationally independent of the requested modification in terms of report generation;
accessing a cached copy of the identified interim result(s); and
generating a modified version of the report in the memory based on at least the requested modification and the cached interim result(s).

9. The configured medium of claim 8, wherein the identifying step automatically identifies at least one of the following interim group tree results:
a data row sorting result;
a data row filtering result;
a data grouping result;
a group instance sorting result;
a group instance filtering result;
an aggregation at grouping scope result.

10. The configured medium of claim 8, wherein the identifying step automatically identifies at least one of the following interim layout results:
a report item runtime position result;
a report item runtime dimension result;
a repeating group data header result;
a page breaks result;
a keep-together result;
a keep-with result;
a text box sizing result;
an image sizing result.

11. The configured medium of claim 8, wherein the identifying step automatically identifies at least one of the following interim format results:
a background result;
a border result;
a padding result;
a text style result.

12. The configured medium of claim 8, wherein the identifying step automatically identifies at least two of the following interim results: an interim group tree result, an interim layout result, interim format result.

13. A computer system comprising:
a logical processor;
a memory in operable communication with the logical processor;
a report definition residing in the memory;
a requested modification of the report definition, also residing in the memory; and
at least one report processing interim result which is computationally independent of the requested modification in terms of report generation, and which also resides in the memory.

14. The system of claim 13, further comprising a modified version of the report which also resides in the memory and which is based on at least the requested modification and the cached interim result(s).

15. The system of claim 13, further comprising a report generation module configured to generate a modified version of the report based on at least the requested modification and the cached interim result(s).

16. The system of claim 13, further comprising an interim results identification module configured to identify at least one report processing interim result which is computationally independent of the requested modification in terms of report generation.

17. The system of claim 13, further comprising an interim results identification module configured to identify at least one report processing interim result in the form of a report item runtime dimension and/or a runtime position which is computationally independent of the requested modification in terms of report generation.

18. The system of claim 13, further comprising an interim results identification module configured to identify at least three of the following report processing interim results when they are computationally independent of the requested modification in terms of report generation:
a data grouping result;
a data row sorting result;
a group instance sorting result;
a data row filtering result;
a group instance filtering result;
an aggregation at grouping scope result;
a repeating group data header result;
a page breaks result;
a keep-together result;
a keep-with result;
a text box sizing result;
an image sizing result;
a background result;
a border result;
a padding result;
a text style result.

19. The system of claim 13, further comprising an interim results identification module configured to identify at least seven of the following report processing interim results when they are computationally independent of the requested modification in terms of report generation:
a data grouping result;
a data row sorting result;
a group instance sorting result;
a data row filtering result;
a group instance filtering result;
an aggregation at grouping scope result;
a repeating group data header result;
a page breaks result;
a keep-together result;
a keep-with result;
a text box sizing result;
an image sizing result;
a background result;
a border result;
a padding result;
a text style result.

20. The system of claim 13, wherein report processing interim results residing in the memory comprise at least two of the following interim results: an interim group tree result, an interim layout result, interim format result.
